(19) United States
(12) Patent Application Publication
(10) Pub. No.: US 2025/0201229 A1
(43) Pub. Date: Jun. 19, 2025

(54) REAL TIME ON DEVICE VOICE CONVERTER FOR PORTABLE APPLICATIONS

(71) Applicant: Google LLC, Mountain View, CA (US)

(72) Inventors: Shao-Fu Shih, San Jose, CA (US); George Chiachi Sung, San Diego, CA (US); Yang Yang, San Diego, CA (US)

(73) Assignee: Google LLC, Mountain View, CA (US)

(21) Appl. No.: 18/954,928

(22) Filed: Nov. 21, 2024

Related U.S. Application Data
(60) Provisional application No. 63/611,893, filed on Dec. 19, 2023.

(51) Int. Cl. G10L 13/02

(52) U.S. Cl. CPC G10L 13/02

(57) ABSTRACT

A method includes receiving a sequence of acoustic frames characterizing a source speech utterance including semantic information and source speech characteristics, obtaining a latent speaker embedding representing target speech characteristics, and generating, at each of a plurality of output steps, using a content encoder of a voice conversion model, a soft speech representation for a corresponding acoustic frame. The method also includes determining, at each of the plurality of output steps, an acoustic estimation for the corresponding acoustic frame, and generating, at each of the plurality of output steps, using a decoder of the voice conversion model, a synthetic speech representation for the corresponding acoustic frame based on the soft speech representation and the acoustic estimation. The synthetic speech representation includes the semantic information of the source speech utterance and the target speech characteristics of the latent speaker embedding. The decoder is conditioned on the latent speaker embedding.

### CROSS-REFERENCE TO RELATED APPLICATIONS

This U.S. patent application claims priority under 35 U.S.C. § 119 (e) to U.S. Provisional Application 63/611,893, filed on Dec. 19, 2023. The disclosure of this prior application is considered part of the disclosure of this application and is hereby incorporated by reference in its entirety.

### TECHNICAL FIELD

This disclosure relates to real time on device voice converter for portable applications.

### BACKGROUND

Voice conversion systems aim to transform source speech into target speech keeping the content from the source speech unchanged. The target speech output by the voice conversion systems includes different speech characteristics than the source speech. To that end, voice conversion systems enable users to alter speech characteristics of input speech while maintaining the linguistic information from the input speech. Accordingly, voice conversion systems have various potential applications. Yet, current voice conversion systems operate with a high latency (e.g., time between receiving the input speech received and outputting the target speech) such that the voice conversion systems are unsuitable for many applications. For instance, the high latency may be unacceptable for two users communicating with each other using the voice conversion system because of the delay introduced between each user speaking.

### SUMMARY

One aspect of the disclosure provides a computer-implemented method that when executed on data processing hardware causes the data processing hardware to perform operations that include receiving a sequence of acoustic frames characterizing a source speech utterance including semantic information and source speech characteristics, obtaining a latent speaker embedding representing target speech characteristics, and generating, at each of a plurality of output steps, using a content encoder of a voice conversion model, a soft speech representation for a corresponding acoustic frame from the sequence of acoustic frames. The operations also include determining, at each of the plurality of output steps, an acoustic estimation for the corresponding acoustic frame from the sequence of acoustic frames, and generating, at each of the plurality of output steps, using a decoder of the voice conversion model, a synthetic speech representation for the corresponding acoustic frame from the sequence of acoustic frames based on the soft speech representation generated by the content encoder and the acoustic estimation. Here, the synthetic speech representation includes the semantic information of the source speech utterance and the target speech characteristics of the latent speaker embedding. Moreover, the decoder is conditioned on the latent speaker embedding.

Implementations of the disclosure may include one or more of the following optional features. In some implementations, the soft speech representation includes a probability distribution of discrete speech units. The content encoder may include a first encoder convolution layer, a stack of encoder blocks, and a second encoder convolution layer. The decoder includes a first decoder convolution layer, a stack of decoder blocks, and a second decoder convolution layer. Here, each decoder block may include one or more residual units, one or more respective Feature-wise Linear Modulation (FILM) layers, and a strided convolution layer.

In some examples, the operations also include receiving a sequence of acoustic frame characterizing a target speech utterance including target speech characteristics, and for each respective acoustic frame from the sequence of acoustic frames, generating, using a speaker encoder, a corresponding speaker encoding for the respective acoustic frame. In these examples, the operations also include aggregating the speaker encodings generated for the sequence of acoustic frames to generate the latent speaker embedding.

In some implementations, the voice conversion model is trained by a training process based on training data including a plurality of training source speech utterances each paired with a corresponding target speech utterance. Here, for each respective training source speech utterance, the training process may train the voice conversion model by predicting, using the content encoder, a soft speech representation for the respective training source speech utterance; generating, using a Hidden-Unit BERT model, a target soft speech representation for the respective training source speech utterance; determining a cross-entropy loss based on the predicted soft speech representation and the target soft speech representation; and training the content encoder based on the cross-entropy loss.

In some examples, the training process further trains the voice conversion model or a multi-scale Short-Time Fourier Transform (STFT) discriminator by: generating, using the decoder, a synthetic speech representation for the predicted soft speech representation; receiving, as input to the multi-scale STFT discriminator, a respective one of the synthetic speech representation generated by the decoder or the respective training source speech utterance; and determining, using the multi-scale STFT discriminator, a classification for the received respective one of the synthetic speech representation generated by the decoder or the respective training target speech utterance. Here, the classification includes a synthetic speech classification or a non-synthetic speech classification. In these examples, the operations also include determining an adversarial loss based on the classification and training the voice conversion model or the multi-scale STFT discriminator based on the adversarial loss. The training process may further train the voice conversion model by determining a feature loss based on an output of the multi-scale STFT discriminator and the corresponding target speech utterance, and training the voice conversion model based on the feature loss. Additionally or alternatively, the training process may further train the voice conversion model by determining a reconstruction loss based on the synthetic speech representation generated by the decoder and the corresponding target speech utterance, and training the voice conversion model based on the reconstruction loss.

Another aspect of the present disclosure provides a system that includes data processing hardware and memory hardware storing instructions that when executed on the data processing hardware causes the data processing hardware to perform operations that include receiving a sequence of acoustic frames characterizing a source speech utterance including semantic information and source speech characteristics, obtaining a latent speaker embedding representing target speech characteristics, and generating, at each of a plurality of output steps, using a content encoder of a voice conversion model, a soft speech representation for a corresponding acoustic frame from the sequence of acoustic frames. The operations also include determining, at each of the plurality of output steps, an acoustic estimation for the corresponding acoustic frame from the sequence of acoustic frames, and generating, at each of the plurality of output steps, using a decoder of the voice conversion model, a synthetic speech representation for the corresponding acoustic frame from the sequence of acoustic frames based on the soft speech representation generated by the content encoder and the acoustic estimation. Here, the synthetic speech representation includes the semantic information of the source speech utterance and the target speech characteristics of the latent speaker embedding. Moreover, the decoder is conditioned on the latent speaker embedding.

This aspect of the disclosure may include one or more of the following optional features. In some implementations, the soft speech representation includes a probability distribution of discrete speech units. The content encoder may include a first encoder convolution layer, a stack of encoder blocks, and a second encoder convolution layer. The decoder includes a first decoder convolution layer, a stack of decoder blocks, and a second decoder convolution layer. Here, each decoder block may include one or more residual units, one or more respective Feature-wise Linear Modulation (FILM) layers, and a strided convolution layer.

In some examples, the operations also include receiving a sequence of acoustic frame characterizing a target speech utterance including target speech characteristics, and for each respective acoustic frame from the sequence of acoustic frames, generating, using a speaker encoder, a corresponding speaker encoding for the respective acoustic frame. In these examples, the operations also include aggregating the speaker encodings generated for the sequence of acoustic frames to generate the latent speaker embedding.

In some implementations, the voice conversion model is trained by a training process based on training data including a plurality of training source speech utterances each paired with a corresponding target speech utterance. Here, for each respective training source speech utterance, the training process may train the voice conversion model by predicting, using the content encoder, a soft speech representation for the respective training source speech utterance; generating, using a Hidden-Unit BERT model, a target soft speech representation for the respective training source speech utterance; determining a cross-entropy loss based on the predicted soft speech representation and the target soft speech representation; and training the content encoder based on the cross-entropy loss.

In some examples, the training process further trains the voice conversion model or a multi-scale Short-Time Fourier Transform (STFT) discriminator by: generating, using the decoder, a synthetic speech representation for the predicted soft speech representation; receiving, as input to the multi-scale STFT discriminator, a respective one of the synthetic speech representation generated by the decoder or the respective training source speech utterance; and determining, using the multi-scale STFT discriminator, a classification for the received respective one of the synthetic speech representation generated by the decoder or the respective training target speech utterance. Here, the classification includes a synthetic speech classification or a non-synthetic speech classification. In these examples, the operations also include determining an adversarial loss based on the classification and training the voice conversion model or the multi-scale STFT discriminator based on the adversarial loss. The training process may further train the voice conversion model by determining a feature loss based on an output of the multi-scale STFT discriminator and the corresponding target speech utterance, and training the voice conversion model based on the feature loss. Additionally or alternatively, the training process may further train the voice conversion model by determining a reconstruction loss based on the synthetic speech representation generated by the decoder and the corresponding target speech utterance, and training the voice conversion model based on the reconstruction loss.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example real-time voice conversion system.

FIG. 2 is a schematic view of an example voice conversion model.

FIG. 3 is a schematic view of an example training process for training the voice conversion model.

FIG. 4 is a schematic view of an example computing device that may be used to implement the systems and methods described herein.

FIG. 5 is a flowchart of an example arrangement of operations for a method of executing a real-time on-device conversion model.

Like reference symbols in the various drawings indicate like elements.

### DETAILED DESCRIPTION

Voice conversion is the process of converting source speech having source speech characteristics into a synthetic speech representation having target speech characteristics while maintaining semantic information from the source speech. Put another way, voice conversion alters the way speech sounds without altering the actual semantic content of the speech. Thus, voice conversion may be used in various speech-related applications. Yet, many speech-related applications have strict latency requirements (i.e., delay between receiving speech input and generating synthetic speech output) that current voice conversion systems are not able to achieve. For instance, many speech-related applications may benefit from using voice conversion including telephone calls, video conferencing, and other smart device applications, to name a few. For example, the video conferencing application may use voice conversion to normalize speech from one or more users that have a speech imparity such as a nasally speech due to a speaker being sick or non-standard speech intonations for child or elderly speakers. In this example, the voice conversion may correct the speech imparity such that the speech imparity is not noticeable to other users on the video conference. In another example, voice conversion may be used by a user to conceal speech characteristics of their voice when speaking remotely with a stranger. For instance, during a telephone call or communicating with a stranger through a speaker of a smart-doorbell, the user may want to conceal their voice such that the stranger cannot identify the user. In each of these examples, significant latency of the voice conversion may cause using voice conversion to be unsuitable for users.

To that end, implementations herein are directed towards methods and systems for executing a real-time on-device conversion model. The voice conversion model receives a sequence of acoustic frames characterizing a source speech utterance that includes semantic information and source speech characteristics. The voice conversion model also obtains a latent speaker embedding representing target speech characteristics and generates, using a content encoder, a soft speech representation for a corresponding acoustic frame. The voice conversion model also determines an acoustic estimation for the corresponding acoustic frame. Finally, the voice conversion model generates, using a decoder, a synthetic speech representation for the corresponding acoustic frame based on the soft speech representation generated by the content encoder and the acoustic estimation. The synthetic speech representation includes the semantic information of the source speech utterance and the target speech characteristics of the latent speaker embedding. Notably, the decoder is conditioned on the latent speaker embedding.

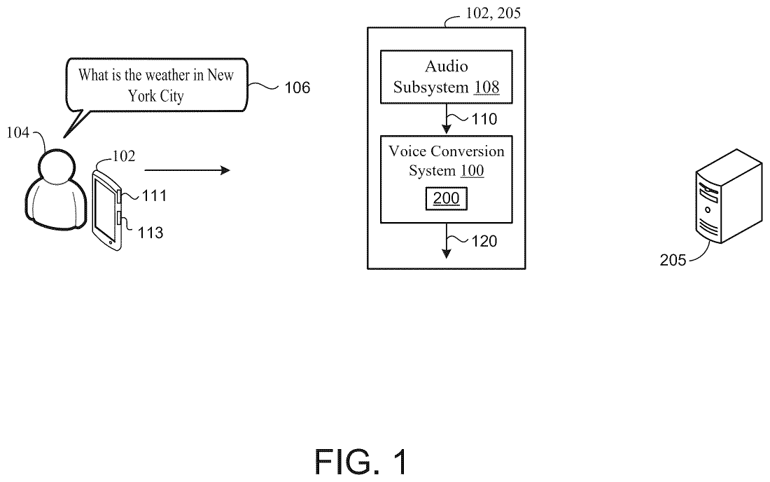

FIG. 1 illustrates a real-time voice conversion system 100 implementing a voice conversion model 200 that resides on a user device 102 of a user 104 and/or on a remote computing device 205 (e.g., one or more servers of a distributed system executing in a cloud-computing environment) in communication with the user device 102. Although depicted as a mobile computing device (e.g., a smart phone), the user device 102 may correspond to any type of computing device such as, without limitation, a tablet device, a smart speaker/display, a smart appliance, an automotive infotainment system, or an Internet-of-Things (IoT) device, and is equipped with data processing hardware and memory hardware.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the real-time voice conversion system 100. In the example shown, the user speaks a respective utterance 106 in a natural language of English for the phrase “What is the weather in New York City?” and the audio subsystem 108 converts the utterance 106 into corresponding acoustic frames 110 for input to the real-time voice conversion system 100. Thereafter, the voice conversion model 200 receives, as input, the acoustic frames 110 corresponding to the utterance 106, and generates, as output, a corresponding synthetic speech representation 120 of the utterance 106. As will become apparent, the synthetic speech representation 120 output by the voice conversion model 200 includes the same linguistic content of the spoken utterance 106, but alters the speech characteristics of the spoken utterance 106. In some examples, the user device 102 that received the spoken utterance 106 audibly outputs (e.g., via one or more speakers) the synthetic speech representation 120. In other examples, the user device 102 sends the synthetic speech representation 120 to one or more other user devices in communication with the user device 102 via a network causing the one or more other user devices to audibly output the synthetic speech representation 120. For instance, the utterance 106 may correspond to a message the user 104 is sending to another user in which another user device audible outputs the synthetic speech representation 120 for the other user to listen to the message conveyed in the spoken utterance 106. The synthetic speech representations 120 may be in a frequency-domain and a vocoder (e.g., a neural vocoder) may convert the synthetic speech representations 120 into time-domain audio for output as synthesized speech corresponding to the input utterance 106.

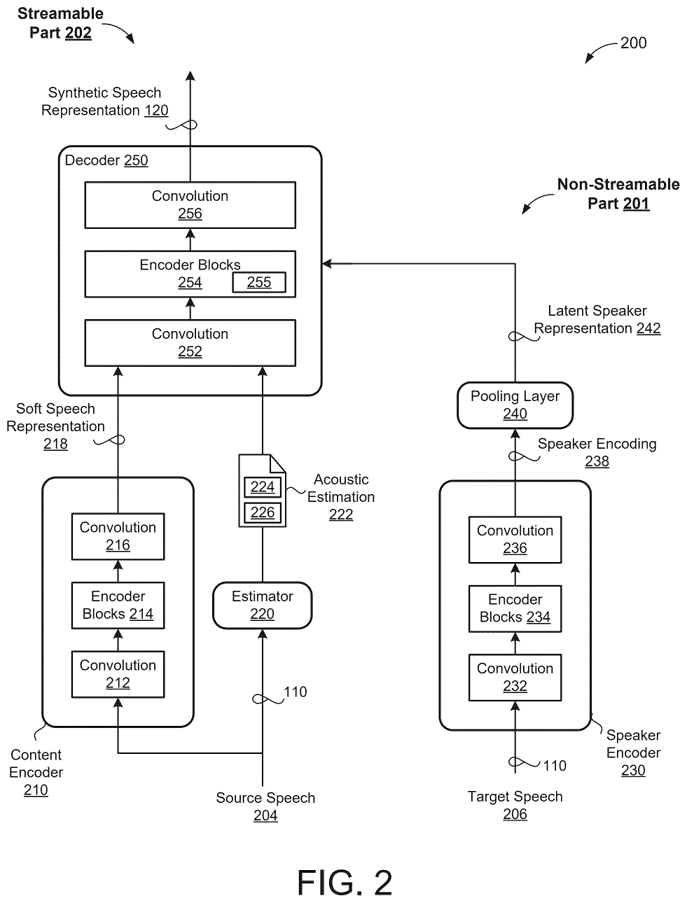

Referring to FIG. 2, in some implementations, the voice conversion model 200 includes a convolutional network model architecture which adheres to latency constraints associated with on-device interactive applications. Moreover, the convolutional network model architecture provides a small computational footprint that utilizes less computational and memory resources than conventional voice conversion models thereby making the convolutional network model architecture suitable for performing voice conversion entirely on the user device 102 (e.g., no communication with the remote computing device 205 is required). In short, the convolutional network model architecture enables the voice conversion model 200 to be employed for various on-device applications having strict latency requirements.

The voice conversion model 200 is configured to receive, as input, a source speech utterance 204 having source speech characteristics and semantic information and generate, at each of a plurality of output steps, a synthetic speech representation 120 having target speech characteristics different than the source speech characteristics and the semantic information from the source speech utterance 204. The voice conversion model 200 may derive the target speech characteristics from a target speech utterance 206. The target speech utterance 206 may be the same utterance as the source speech utterance, but spoken by a different user. In some examples, the target speech utterance 206 includes multiple utterances to more accurately derive the target speech characteristics. Accordingly, in some examples, the voice conversion model 200 may be employed to conceal the identity of a user that spoke source speech utterance 204 by concealing (i.e., altering) the speech characteristics of that user. In other examples, the voice conversion model 200 may be employed to alter any speech imparities included in source speech utterance 204 such that the resulting synthetic speech representations 120 remove the speech imparities allowing other users to better understand users that have speech imparities.

The voice conversion model 200 includes a non-streamable (i.e., offline) inference part 201 and a streamable inference part 202. The non-streamable inference part 201 operates in a non-streaming (i.e., non-causal) fashion whereby the non-streamable inference part 201 processes additional right context (i.e., future acoustic frames) when generating an output. On the other hand, the streamable inference part 202 of the voice conversion model 200 operates in a streaming (i.e., causal) fashion such that the streamable inference part 202 generates an output for each acoustic frame 110 from the sequence of acoustic frames 110 without processing any additional right context. As will become apparent, in some examples, the voice conversion model 200 executes the non-streamable inference part 201 and stores the outputs generated by the non-streamable inference part 201 before inference to avoid introducing increased latency during inference. Accordingly, during or before inference, the streamable inference part 202 may obtain the outputs stored by the non-streamable inference part 201 to maintain streaming operation.

The non-streamable part 201 includes a speaker encoder 230 and a pooling layer 240. The speaker encoder 230 includes a first encoder convolutional layer 232, a stack of encoder blocks 234, and a second encoder convolutional layer 236. In some examples, the content encoder 210 includes a convolutional neural network architecture. The first encoder convolutional layer 232 includes a plain convolution layer that is followed by the stack of encoder blocks 234. Each encoder block 234 of the stack of encoder blocks 234 includes one or more residual units using dilated convolutions followed by a down-sampling layer in the form of a strided convolution layer. For instance, each encoder block 234 may include 3 residual units including dilation rates of 1, 3, and 9, respectively, followed by the strided convolution layer. The stack of encoder blocks 234 is followed by the second encoder convolutional layer 236 which may be a plain convolution layer.

The speaker encoder 230 receives the target speech utterances 206 having target speech characteristics. For example, the target speech characteristics may include speech characteristics corresponding to a particular voice actor. In another example, the target speech characteristics may include one or more different generic speech characteristics. In this other example, the target speech characteristics may be used to conceal the source speech characteristics and/or normalize any speech imparities included in the source speech characteristics. The target speech utterance 206 may be characterized by a respective sequence of acoustic frames 110. The speaker encoder 230 is configured to receive, as input, the sequence of acoustic frames 110 characterizing the target speech utterances 206 and generate, at each of a plurality of output steps, a speaker encoding 238 for a corresponding acoustic frame 110 from the sequence of acoustic frames 110. Each speaker encoding 238 generated by the speaker encoding 230 represents a per-frame context embedding having the target speech characteristics included in a particular acoustic frame 110. The pooling layer 240 aggregates the speaker encodings 238 generated for the sequence of acoustic frames 110 to generate a latent speaker embedding 242 representing the target speech characteristics. Thus, the latent speaker embedding 242 a per-utterance context embedding.

Since the pooling layer 240 aggregates multiple speaker encodings 238 from multiple acoustic frames 110, the pooling layer 240 operates in a non-streaming fashion. Thus, the non-streamable inference part 201 may generate multiple latent speaker embedding 242 each corresponding to different target speaker characteristics and store (e.g., at memory hardware 113 (FIG. 1)) the latent speaker embeddings 242 in an offline fashion before inference of the voice conversion model 200. Thereafter, the voice conversion model 200 may simply obtain the particular latent speaker embedding 242 representing the target speech characteristics a user desires the synthetic speech representation 120 to have instead of generating the latent speaker embedding 242 during inference.

The streamable inference part 202 of the voice conversion model 200 includes a content encoder 210, an estimator 220, and a decoder 250. The content encoder 210 includes a first encoder convolutional layer 212, a stack of encoder blocks 214, and a second encoder convolutional layer 216. In some examples, the content encoder 210 includes a convolutional neural network architecture. The first encoder convolutional layer 212 includes a plain convolution layer that is followed by the stack of encoder blocks 214. Each encoder block 214 of the stack of encoder blocks 214 includes one or more residual units using dilated convolutions followed by a down-sampling layer in the form of a strided convolution layer. For instance, each encoder block 214 may include 3 residual units including dilation rates of 1, 3, and 9, respectively, followed by the strided convolution layer. The stack of encoder blocks 214 is followed by the second encoder convolutional layer 216 which may be a plain convolution layer. To ensure streaming operation of the content encoder 210, all convolutions are causal. Notably, the content encoder 210 does not include any Feature-wise Linear Modulation (FILM) layers.

The content encoder 210 receives source speech utterances 204 having semantic information and source speech characteristics different than the target speech characteristics. As will become apparent, the voice conversion model 200 alters the source speech characteristics of the source speech utterance 204 while maintaining the semantic information of the source speech utterance 204. The source speech utterance 204 may be characterized by a respective sequence of acoustic frames 110. The content encoder 210 is configured to receive, as input, the sequence of acoustic frames 110 characterizing the source speech utterance 204 and generate, at each of a plurality of output steps, a soft speech representation 218 for a corresponding acoustic frame 110 from the sequence of acoustic frames 110.

In some examples, the soft speech representation 218 output by the content encoder 210 includes a probability distribution over possible discrete speech units. Here, possible discrete speech units correspond to a set of speech labels each representing a sound in a specified natural language. Accordingly, the probability distribution over possible discrete speech units may include a set of values indicative of the likelihood of occurrence of each of a predetermined set of discrete speech units. Advantageously, the probability distribution over possible discrete speech units provides a middle ground between raw continuous speech features (i.e., not discrete) and only discrete speech units which creates an information bottleneck that decreases speech intelligibility. The content encoder 210 outputs the soft speech representation 218 generated for each acoustic frame 110 from the sequence of acoustic frames 110 to the decoder 250.

In some examples, generating synthetic speech representations 120 from the soft speech representation 218 alone produces speech with a flattened pitch envelope thereby having a detrimental effect on speech intonation. The flattened pitch envelope may be caused by the soft speech representation 218 lacking tonal and acoustic energy information. To that end, the estimator 220 is configured to receive, as input, the sequence of acoustic frames 110 characterizing the source speech utterance 204 and determine, at each of the plurality of output steps, an acoustic estimation 222 for a corresponding acoustic frame 110 from the sequence of acoustic frames 110. The estimator 220 may be integrated with the content encoder 210 or separate from the content encoder 210. The acoustic estimation 222 includes a fundamental frequency estimation 224 and an energy estimation 226. In some examples, the fundamental frequency estimation 224 includes a pitch estimation, a cumulative mean normalized difference value at an estimated period, and/or an estimated unvoiced (e.g., aperiodic) signal predicate. To avoid suggesting speaker timbre parameters to the decoder 250, the estimator 220 normalizes the fundamental frequency estimation 224 based on an utterance-level mean and an utterance-level standard deviation. During streaming inference, the estimator 220 outputs running averages of the fundamental frequency to maintain streaming operation (i.e., causality). Moreover, the estimator 220 determines the energy estimation using a sample variance of the acoustic frames 110.

The decoder 250 includes a first decoder convolutional layer 252, a stack of decoder blocks 254, and a second decoder convolutional layer 256. In some configurations, the decoder 250 includes a convolutional neural network architecture. The first decoder convolutional layer 252 includes a plain convolution layer that is followed by the stack of decoder blocks 254. Each decoder block 254 of the stack of decoder blocks 254 includes one or more residual units using dilated convolutions followed by an up-sampling layer in the form of a strided convolution layer. For instance, each decoder block 254 may include 3 residual units including dilation rates of 1, 3, and 9, respectively, followed by the strided convolution layer. In contrast to the stack of encoder blocks 214, the stack of decoder blocks 254 include a FILM layer 255 between each residual unit. The FILM layers 255 are conditioned on the latent speaker embedding 242 such that the FILM layer 255 integrate the latent speaker embedding 242 into the synthetic speech representation 120 output by the decoder 250. Stated differently, the FILM parameters are configured to bias the synthetic speech representation 120 to have the target speech characteristics instead of the source speech characteristics. In particular, each FILM layer 255 integrates the latent speaker embedding 242 by scaling and biasing the residual unit output using the latent speaker embedding 242. The stack of decoder blocks 254 is followed by the second decoder convolutional layer 256 which may be a plain convolution layer. To ensure streaming operation of the decoder 250, all convolutions are causal.

The decoder 250 is configured to receive, as input, the soft speech representation 218 generated by the content encoder 210 at each of the plurality of output steps and the acoustic estimation 222 determined by the estimator 220 at each of the plurality of output steps and generate, at each of the plurality of output steps, a corresponding synthetic speech representation 120 based on the soft speech representation 218 and the acoustic estimation 222. Thus, each synthetic speech representation 120 is generated based on the same acoustic frame 110 from which the corresponding soft speech representation 218 and the corresponding acoustic estimation 222 were generated from. Notably, the streamable inference part 202 conditions the decoder 250 on the latent speaker embedding 242 such that the synthetic speech representation 120 output by the decoder 250 includes the target speech characteristics of the latent speaker embedding 242. Simply put, conditioning the decoder on the latent speaker embedding 242 causes the decoder 250 to generate the synthetic speech representation 120 having the target speech characteristics instead of the source speech characteristics. In short, the decoder 250 generates the synthetic speech representation 120 having the target speech characteristics of the target speech utterance 206 while maintaining the semantic information from the source speech utterance 204.

Advantageously, the voice conversion model 200 may be employed in various speech conversion scenarios. In one example scenario, the user 104 may receive a phone call at their user device 102 (FIG. 1) from an unknown or spam caller that states “we've detected suspicious activity on your account” to which the user responds with “what kind of suspicious activity?” In this example, the user's response of “what kind of suspicious activity?” represents source speech 204 input to the voice conversion model 200 that generates a corresponding synthetic speech representation 120 having target speech characteristics instead of speech characteristics of the user. As such, the synthetic speech representation 120 having the target speech characteristics are sent to the unknown or spam caller instead of the source speech 204 thereby concealing the speech characteristics of the user from the unknown caller.

In another example scenario, the user 104 may receive a notification at the user device 102 (FIG. 1) from an Internet-of-Things (IoT) doorbell indicating that someone is at the door. The notification may also be received from other IoT devices such as an IoT camera, or IoT speaker. The user may determine based on a video feed from the IoT doorbell that the user does not know the person at the door. In this scenario, the user may speak into the user device 102 whereby the speech is output via a microphone of the IoT doorbell. To conceal the voice characteristics of the user, the voice conversion model 200 may generate a corresponding synthetic speech representation 120 having target speech characteristics from the speech input to the user device 102 (e.g., the source speech 204). Here, the voice conversion model 200 may execute on the user device 102 and output the synthetic speech representation 120 from the IoT doorbell and/or operate on the IoT doorbell. By executing the voice conversion model 200 on the user device 102 and outputting the synthetic speech representation 120 from the IoT doorbell, the IoT doorbell leverages computing resources of other devices instead of using computing resources of the IoT doorbell itself. That is, the voice conversion model 200 may execute on an edge device an output the synthetic speech representation 120 on another device.

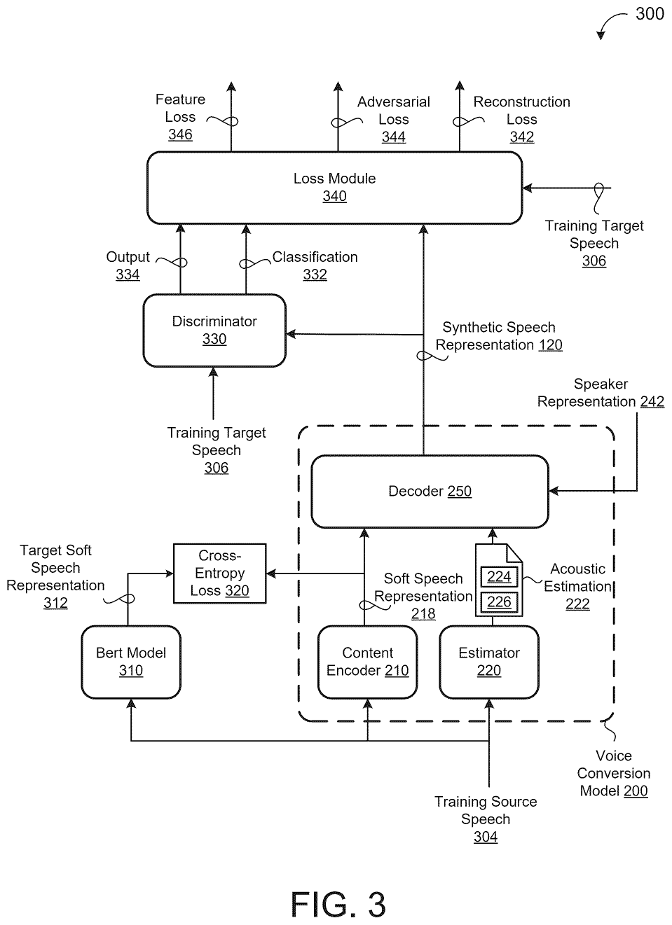

FIG. 3 illustrates an example training process 300 for training the voice conversion model 200. The training process 300 may execute on the remote computing system 205 or other computing event for training the voice conversion model 200 and the trained voice conversion model 200 may be pushed or loaded onto the user device 102 for execution thereon. The training process 300 trains the voice conversion model 200 using training data that includes a plurality of training source speech utterances 304 each paired with a corresponding training target speech utterance 306. Here, the training source speech utterances 304 include source speech characteristics with semantic information and the training target speech utterances 306 include target speech characteristics different than the source speech characteristics. The semantic information of the training target speech utterances 306 may be the same or different than the training source speech utterances 304.

The training process 300 employs the voice conversion model 200, a pre-trained Hidden-Unit Bidirectional Encoder Representations from Transformers (HuBERT) model 310, a discriminator 330, and a loss module 340. For each respective training source speech utterance 304, the content encoder 210 generates a corresponding soft speech representation 218 and the estimator 220 generates a corresponding acoustic estimation 222 (e.g., including fundamental frequency estimation 224 and an energy estimation 226). Each respective training source speech utterance 304 may be characterized by a sequence of acoustic frames 110 (FIG. 1) such that the content encoder 210 generates a corresponding soft speech representation 218 and the estimator 220 generates a corresponding acoustic estimation 222 for each acoustic frame 110. The content encoder 210 may apply a stop gradient operation such that the content encoder 210 does not learn to leak additional speaker information through the soft speech representations 218 by bypassing the latent speaker embedding 242. Thereafter, the decoder 250 generates a corresponding synthetic speech representation 120 based on the soft speech representation 218 and the acoustic estimation 222. Notably, the content encoder 210 is conditioned on the latent speaker embedding 242 to generate the synthetic speech representation 120 that has the target speech characteristics. That is, the training process 300 conditions the decoder 250 using a respective latent speaker embedding 242 that corresponds with the training target speech utterance 306 that the voice conversion model 200 is aiming to match. The decoder 250 output each synthetic speech representation 120 to the discriminator 330 and the loss module 340.

The HuBERT model 310 is trained to generate target soft speech representations 312 based on input utterances. To that end, the HuBERT model 310 is configured to receive, as input, each respective training source speech utterance 304 and generate a corresponding target soft speech representation 312 based on the respective training source speech utterance 304. In some instances, the HuBERT model 310 generates a corresponding target soft speech representation 312 for each acoustic frame 110 from the sequence of acoustic frames 110 (FIG. 1) characterizing the training source speech utterance 304. Thereafter, for each respective training source speech utterance 304, the training process 300 determines a cross-entropy loss 320 based on the predicted soft speech representation 218 and the target soft speech representation 312. That is, the target soft speech representation 312 serves as a pseudo ground-truth label such that the training process 300 compares the predicted soft speech representation 218 and the target soft speech representation 312 output for each training source speech utterance 304. The training process 300 trains the content encoder 210 based on the cross-entropy loss 320 determined for each training source speech utterance 304 by updating parameters of the content encoder 210.

The loss module 340 is configured to receive, as input, the synthetic speech representation 120 generated by the voice conversion model 200 for each respective training source speech utterance 304 and the corresponding training target speech utterance 306 and determined a reconstruction loss 342. In particular, the loss module 340 determines the reconstruction loss 342 by comparing the synthetic speech representation 120 having predicted target speech characteristics with the training target speech utterance 306 having the actual target speech characteristics. As such, the reconstruction loss 342 teaches the voice conversion model 200 to generate synthetic speech representation 120 that sound acoustically similar to the training target speech utterances 306. The training process 300 trains the voice conversion model 200 based on the reconstruction loss 342 determined for each training source speech utterance 304 by updating parameters of the content encoder 210, the estimator 220, and/or the decoder 250.

The discriminator 330 may include a multi-scale Short-Time Fourier Transform (STFT) discriminator. The discriminator 330 is configured to receive, as input, the training target speech utterances 306 and the synthetic speech representations 120 generated by the decoder 250. At each of a plurality of iterations, the discriminator 330 receives either a respective one of the training target speech utterances 306 or a respective one of the synthetic speech representations 120 generated by the decoder 250 and is configured to determine a classification 332 for the received utterance as a synthetic classification (e.g., generated by the voice conversion model 200) or a non-synthetic classification (e.g., one of the training target speech utterances 306). The discriminator 330 outputs each classification 332 to the loss module 340 that determines a corresponding adversarial loss 344 based on whether the classification 332 accurately classified the utterance or not. The training process 300 may train the voice conversion model 200 and/or the discriminator 330 based on the adversarial losses 344 by updating parameters of the voice conversion model 200 and/or the discriminator 330. To that end, the adversarial loss 344 may teach the discriminator 330 to more accurately disambiguate whether a received utterance is generated by the voice conversion model 200 or is one of the training target speech utterances 306 and/or teach the voice conversion model 200 to generate more realistic sounding (i.e., intelligible) synthetic speech representations 120.

In some examples, the discriminator 330 includes a stack of internal layers (e.g., convolution layers). In these examples, each internal layer may generate an output 334 for a synthetic speech representation 120 and a corresponding training target speech utterance 306. Here, the loss module 340 may receive the output 334 from the discriminator 330 and determine a feature loss 346 by determining an average absolute difference between the internal layer outputs 334 of the discriminator 330 and the internal layer outputs 334 for the corresponding training target speech utterances 306. The training process 300 may train the voice conversion model 200 based on the feature loss 346 determined for each training target speech utterance 306.

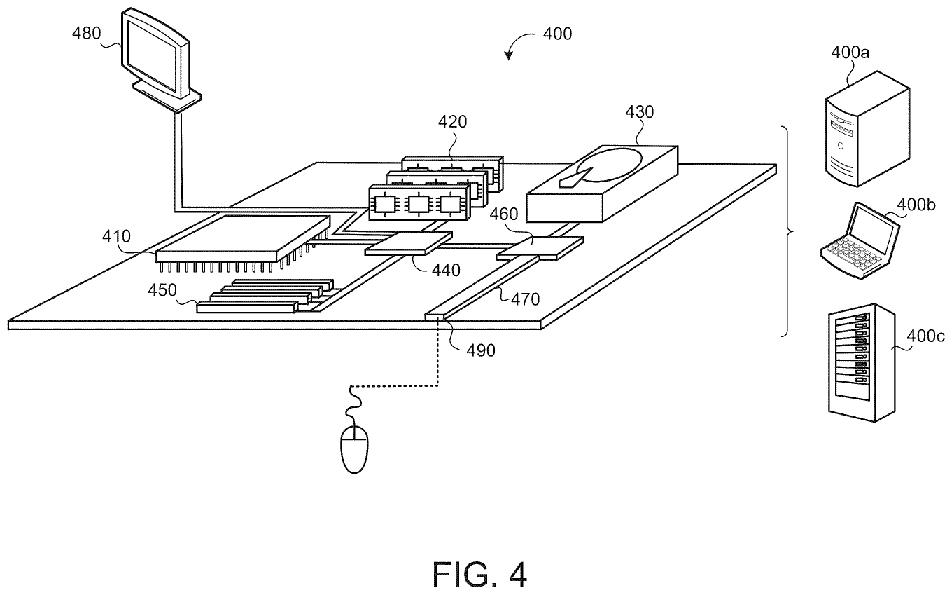

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

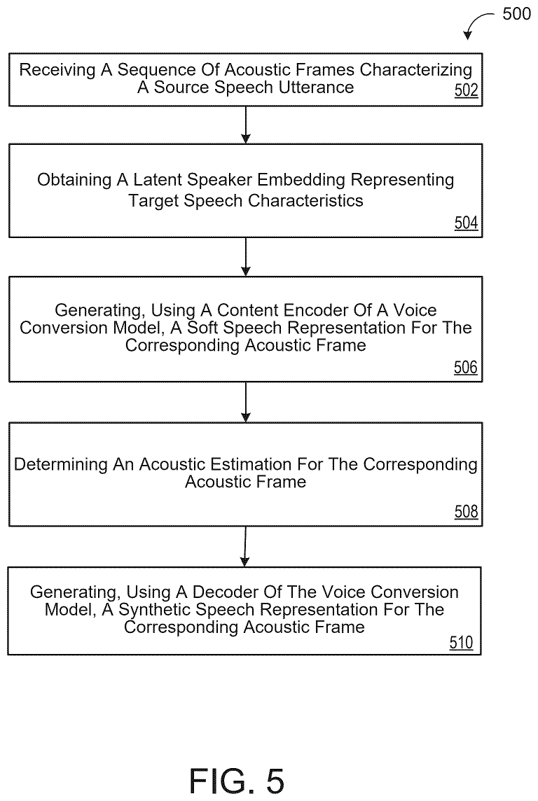

FIG. 5 is a flowchart for an example arrangement of operations for a method 500 of executing a real-time on-device voice conversion model 200. The operations for the method 500 may execute on the data processing hardware 111 of the user device 102 based on instructions stored on the memory hardware 113 of the user device 102. At operation 502, the method 500 includes receiving a sequence of acoustic frames 110 characterizing a source speech utterance 204 that includes semantic information and source speech characteristics. At operation 504, the method 500 includes obtaining a latent speaker embedding 242 representing target speech characteristics.

At operation 506, the method 500 includes generating, at each of a plurality of output steps, using a content encoder 210 of the voice conversion model 200, a soft speech representation 218 for a corresponding acoustic frame 110 from the sequence of acoustic frames 110. At operation 508, the method 500 includes determining, at each of the plurality of output steps, an acoustic estimation 222 for the corresponding acoustic frame 110 from the sequence of acoustic frames 110.

At operation 510, the method 500 includes generating, at each of the plurality of output steps, using a decoder 250 of the voice conversion model 200, a synthetic speech representation 120 for the corresponding acoustic frame 110 from the sequence of acoustic frames 110 based on the soft speech representation 218 generated by the content encoder 210 and the acoustic estimation 222. The synthetic speech representation 120 includes the semantic information of the source speech utterance 204 and the target speech characteristics of the latent speaker embedding 242. Moreover, the decoder 250 is conditioned on the latent speaker embedding 242.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method that when executed on data processing hardware causes the data processing hardware to perform operations comprising:
receiving a sequence of acoustic frames characterizing a source speech utterance comprising semantic information and source speech characteristics;
obtaining a latent speaker embedding representing target speech characteristics;
generating, at each of a plurality of output steps, using a content encoder of a voice conversion model, a soft speech representation for a corresponding acoustic frame from the sequence of acoustic frames;
determining, at each of the plurality of output steps, an acoustic estimation for the corresponding acoustic frame from the sequence of acoustic frames; and
generating, at each of the plurality of output steps, using a decoder of the voice conversion model, a synthetic speech representation for the corresponding acoustic frame from the sequence of acoustic frames based on the soft speech representation generated by the content encoder and the acoustic estimation, the synthetic speech representation comprising the semantic information of the source speech utterance and the target speech characteristics of the latent speaker embedding, wherein the decoder is conditioned on the latent speaker embedding.

2. The computer-implemented method of claim 1, wherein the soft speech representation comprises a probability distribution of discrete speech units.

3. The computer-implemented method of claim 1, wherein the content encoder comprises:
a first encoder convolution layer;
a stack of encoder blocks; and
a second encoder convolution layer.

4. The computer-implemented method of claim 1, wherein the decoder comprises:
a first decoder convolution layer;
a stack of decoder blocks; and
a second decoder convolution layer.

5. The computer-implemented method of claim 4, wherein each decoder block comprises:
one or more residual units;
one or more respective Feature-wise Linear Modulation (FILM) layers; and
a strided convolution layer.

6. The computer-implemented method of claim 1, wherein the operations further comprise:
receiving a sequence of acoustic frame characterizing a target speech utterance comprising target speech characteristics;
for each respective acoustic frame from the sequence of acoustic frames, generating, using a speaker encoder, a corresponding speaker encoding for the respective acoustic frame; and
aggregating the speaker encodings generated for the sequence of acoustic frames to generate the latent speaker embedding.

7. The computer-implemented method of claim 1, wherein the voice conversion model is trained by a training process based on training data comprising a plurality of training source speech utterances each paired with a corresponding target speech utterance.

8. The computer-implemented method of claim 7, wherein, for each respective training source speech utterance, the training process trains the voice conversion model by:
predicting, using the content encoder, a soft speech representation for the respective training source speech utterance;
generating, using a Hidden-Unit BERT model, a target soft speech representation for the respective training source speech utterance;
determining a cross-entropy loss based on the predicted soft speech representation and the target soft speech representation; and
training the content encoder based on the cross-entropy loss.

9. The computer-implemented method of claim 8, wherein the training process further trains the voice conversion model or a multi-scale Short-Time Fourier Transform (STFT) discriminator by:
generating, using the decoder, a synthetic speech representation for the predicted soft speech representation;
receiving, as input to the multi-scale STFT discriminator, a respective one of the synthetic speech representation generated by the decoder or the respective training source speech utterance;
determining, using the multi-scale STFT discriminator, a classification for the received respective one of the synthetic speech representation generated by the decoder or the respective training target speech utterance, the classification comprising a synthetic speech classification or a non-synthetic speech classification;
determining an adversarial loss based on the classification; and
training the voice conversion model or the multi-scale STFT discriminator based on the adversarial loss.

10. The computer-implemented method of claim 9, wherein the training process further trains the voice conversion model by:
determining a feature loss based on an output of the multi-scale STFT discriminator and the corresponding target speech utterance; and
training the voice conversion model based on the feature loss.

11. The computer-implemented method of claim 9, wherein the training process further trains the voice conversion model by:
determining a reconstruction loss based on the synthetic speech representation generated by the decoder and the corresponding target speech utterance; and
training the voice conversion model based on the reconstruction loss.

12. A system comprising:
data processing hardware; and
memory hardware in communication with the data processing hardware, the memory hardware storing instructions that when executed on the data processing hardware cause the data processing hardware to perform operations comprising:
receiving a sequence of acoustic frames characterizing a source speech utterance comprising semantic information and source speech characteristics;
obtaining a latent speaker embedding representing target speech characteristics;
generating, at each of a plurality of output steps, using a content encoder of a voice conversion model, a soft speech representation for a corresponding acoustic frame from the sequence of acoustic frames;
determining, at each of the plurality of output steps, an acoustic estimation for the corresponding acoustic frame from the sequence of acoustic frames; and
generating, at each of the plurality of output steps, using a decoder of the voice conversion model, a synthetic speech representation for the corresponding acoustic frame from the sequence of acoustic frames based on the soft speech representation generated by the content encoder and the acoustic estimation, the decoder conditioned on the latent speaker embedding and the synthetic speech representation comprising the semantic information of the source speech utterance and the target speech characteristics of the latent speaker embedding.

13. The system of claim 12, wherein the soft speech representation comprises a probability distribution of discrete speech units.

14. The system of claim 12, wherein the content encoder comprises:
a first encoder convolution layer;
a stack of encoder blocks; and
a second encoder convolution layer.

15. The system of claim 12, wherein the decoder comprises:
a first decoder convolution layer;
a stack of decoder blocks; and
a second decoder convolution layer.

16. The system of claim 15, wherein each decoder block comprises:
one or more residual units;
one or more respective Feature-wise Linear Modulation (FILM) layers; and
a strided convolution layer.

17. The system of claim 12, wherein the operations further comprise:
receiving a sequence of acoustic frame characterizing a target speech utterance comprising target speech characteristics;
for each respective acoustic frame from the sequence of acoustic frames, generating, using a speaker encoder, a corresponding speaker encoding for the respective acoustic frame; and
aggregating the speaker encodings generated for the sequence of acoustic frames to generate the latent speaker embedding.

18. The system of claim 12, wherein the voice conversion model is trained by a training process based on training data comprising a plurality of training source speech utterances each paired with a corresponding target speech utterance.

19. The system of claim 18, wherein, for each respective training source speech utterance, the training process trains the voice conversion model by:
predicting, using the content encoder, a soft speech representation for the respective training source speech utterance;
generating, using a Hidden-Unit BERT model, a target soft speech representation for the respective training source speech utterance;
determining a cross-entropy loss based on the predicted soft speech representation and the target soft speech representation; and
training the content encoder based on the cross-entropy loss.

20. The system of claim 19, wherein the training process further trains the voice conversion model or a multi-scale Short-Time Fourier Transform (STFT) discriminator by:
generating, using the decoder, a synthetic speech representation for the predicted soft speech representation;
receiving, as input to the multi-scale STFT discriminator, a respective one of the synthetic speech representation generated by the decoder or the respective training source speech utterance;
determining, using the multi-scale STFT discriminator, a classification for the received respective one of the synthetic speech representation generated by the decoder or the respective training target speech utterance, the classification comprising a synthetic speech classification or a non-synthetic speech classification;
determining an adversarial loss based on the classification; and
training the voice conversion model or the multi-scale STFT discriminator based on the adversarial loss.

21. The system of claim 20, wherein the training process further trains the voice conversion model by:
determining a feature loss based on an output of the multi-scale STFT discriminator and the corresponding target speech utterance; and
training the voice conversion model based on the feature loss.

22. The system of claim 20, wherein the training process further trains the voice conversion model by:
determining a reconstruction loss based on the synthetic speech representation generated by the decoder and the corresponding target speech utterance; and
training the voice conversion model based on the reconstruction loss.
